(19) United States
(12) Patent Application Publication
(10) Pub. No.: US 2010/0145923 A1
(43) Pub. Date: Jun. 10, 2010

(54) RELAXED FILTER SET

(75) Inventors: Yuan Wang, Issaquah, WA (US); Tiffany Kumi Dohzen, Seattle, WA (US); Dehu Qi, Sammamish, WA (US); Rangan Majumder, Redmond, WA (US); Gargi Ghosh, Redmond, WA (US); Novia Rosalinda Wijaya, Bellevue, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/328,450

(22) Filed: Dec. 4, 2008

(51) Int. Cl. G06F 17/30; G06F 7/00

(52) U.S. Cl. 707/708; 707/E17.017

(57) ABSTRACT

Searching for a subset of the keywords in a search-engine query is described herein. The search-engine query is parsed into keywords. The keywords are checked against an inverted index to determine whether any web documents include the subset of keywords. Documents containing the subset of keywords are listed in a search-results list and transmitted back to the user.

### BACKGROUND

Most current search engines use keyword-based searching to locate web pages or online information on the World Wide Web (Web). The search engines use web crawlers to traverse online web pages and categorize the web pages' content into inverted indexes. An inverted index is an index data structure that stores a mapping of keywords to online documents where the keywords have been located by a web crawler. An entry in an inverted index contains a keyword and a list of documents that contain the keyword of interest. When a user issues a query such as “dentists in Seattle Wash.” to the search engine, the search engine can quickly retrieve the list of online documents containing these four keywords by looking up the inverted index.

Most keyword-based search engines operate on the assumption that the user intends to only find documents that contain all of the search terms. Conventional search engines answer submitted queries by locating documents containing every keyword submitted. This is typically referred to as “and-based searching.” When a user over-specifies a query by including unnecessary terms, however, a relevant document that is missing one or more of the extra terms will not be located. In the above example, the inverted index may only specify documents that include the keywords “dentists” and “Seattle” but not “in” and “Washington.” Consequently, the search engine will not return documents that do not include all four keywords.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One aspect of the invention is directed to locating web documents that satisfy a subset of the words in a search-engine query. Once a user submits the query to a search engine, the search engine parses the query into keywords and determines whether a subset of the keywords have been found by a web crawler in any online documents. To do so, the search engine may query the words against an inverted index of terms found by a web crawler and check the documents the terms were found in. Also, some keywords in the search-engine query may be designated as “non-relaxed” keywords. Non-relaxed keywords, if specified, must be included in any document identified as matching the query. The search engine returns the identified documents in a search-results list.

Another aspect of the invention is directed to a server configured to return the above search-results list. The server is configured to receive the search-engine query from the client computing device, parse the query into keywords the inverted index to determine whether any documents contain the subset of keywords. The server may also be configured to only locate documents that also contain any non-relaxed keywords.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing device, according to one embodiment;

FIG. 2 is a diagram of a table representation of an inverted index, according to one embodiment;

FIG. 3A is a block diagram of a networked environment for performing relaxed searching on a search engine, according to one embodiment;

FIG. 3B illustrates a block diagram and the flow of information across a networked environment configured to perform relaxed searching, according to one embodiment;

FIG. 4 is a flow diagram illustrating steps for performing relaxed searching on a search engine, according to one embodiment; and

FIG. 5 is a diagram of a search-results list from a search engine performing relaxed searching, according to one embodiment.

### DETAILED DESCRIPTION

The subject matter described herein is presented with specificity to meet statutory requirements. The description herein, however, is not intended to limit the scope of this patent. Instead, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

In general, embodiments described herein are directed toward a search engine that creates a list of results for a search-engine query by identifying documents that include only a subset of the keywords submitted by a user. In one embodiment, once the user submits the search-engine query, the search engine checks an inverted index to locate documents that contain each separate keyword in the query. The identified documents for each word may then be compared to see if the documents contain any of the other keywords. Only documents containing a subset of the keywords is identified for the results list. The subset of keywords equals the total number of keywords (N) minus a given number (K) less than N, resulting in the subset equaling N−K words long. For example, if a query contained “Seattle dentists in Washington,” and K was equal to 1, documents would only have to include any three of the above words to be included on the results list. K can vary by any number and can be set either by an administrator of the search engines or by the search engine automatically using well-known heuristics. For the sake of clarity, N minus K is represented herein as N−K.

In an alternative embodiment, the search engine may be configured to only search for web documents containing a lesser number of words (M) in a given query of N words, with M<N. For example, looking again at the above query, the search engine may be configured in this embodiment to search for documents that have any two or three of the words “Seattle,” “dentists,” “in,” and “Washington.” Thus, in this embodiment, any M words of the query may be matched across web documents.

A search-engine query, as discussed herein, refers to any keyword search of the Web by a search engine. Web-search queries may be initiated in any number of ways well known to those skilled in the art. For example, a user may enter keywords or phrases into a text field on a search engine's web page or into a text field of a web browser's tool bar. It will be apparent to those skilled in the art that numerous ways for initiating a search-engine query are also possible and need not be discussed at length herein. While embodiments discussed herein refer to accessing web pages via the Internet, other embodiments may access electronic documents via a private network.

In one embodiment, the present invention takes the form of a computer-program product that includes computer-useable instructions embodied on one or more computer-readable media. Computer-readable media include both volatile and nonvolatile media, removable and nonremovable media, and contemplates media readable by a database, a switch, and various other network devices.

By way of example, and not limitation, computer-readable media comprise computer-storage media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory components can store data momentarily, temporarily, or permanently.

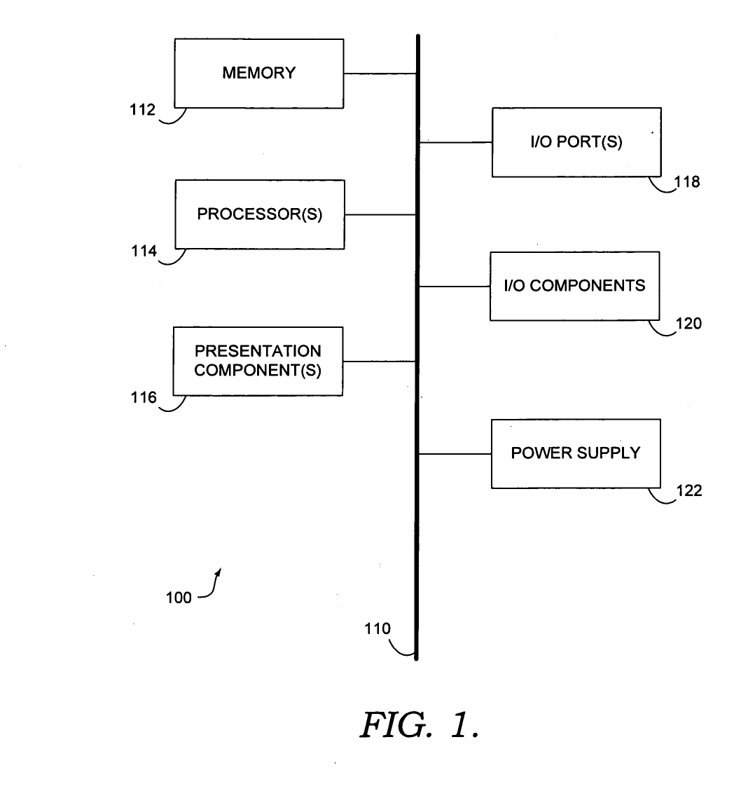

Having briefly described a general overview of the embodiments described herein, an exemplary operating environment is described below. Referring initially to FIG. 1 in particular, an exemplary operating environment for implementing one embodiment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, smartphone, digital phone, handheld device, BlackBerry®, personal digital assistant (PDA), or other device capable of executing computer instructions.

Embodiments may be described in the general context of computer code or machine-useable instructions, including computer-executable instructions such as program modules, being executed by a computer or other machine, such as a PDA or other handheld device. Generally, program modules including routines, programs, objects, components, data structures, and the like, refer to code that performs particular tasks or implements particular abstract data types. Embodiments described herein may be practiced in a variety of system configurations, including handheld devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

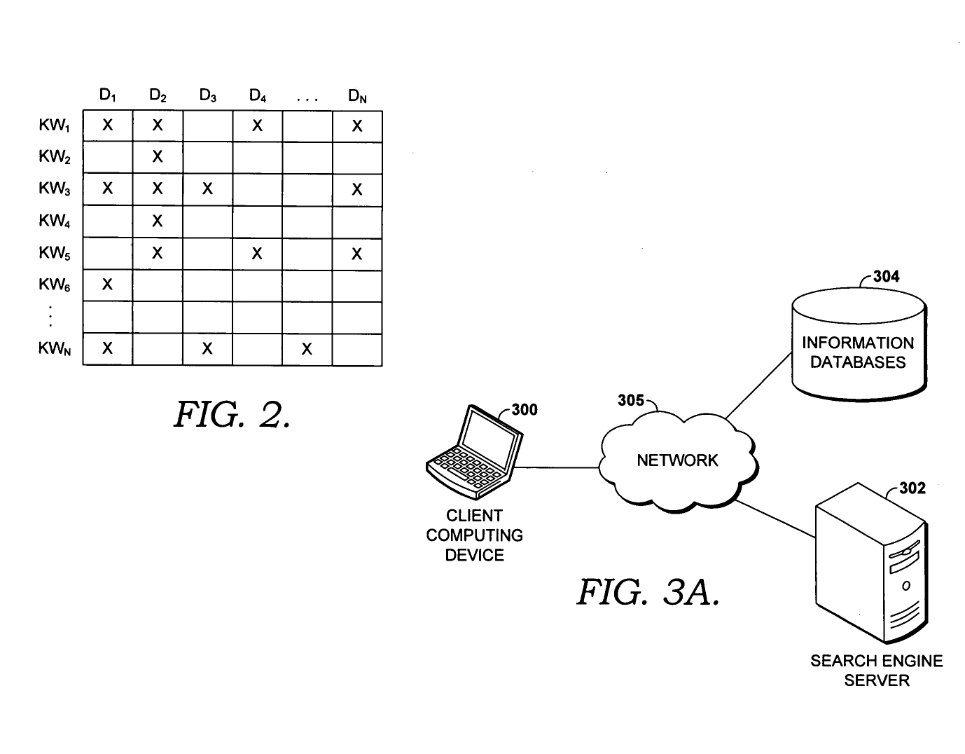

Before proceeding further, a number of key words and phrases should be defined. As alluded to above, an “inverted index” is an index data structure that includes a mapping of keywords identified by a web crawler to online documents. FIG. 2 is a diagram of a table representation of an inverted index in accordance with an embodiment of the invention. Keywords KW1-KWn were noticed in documents D1-Dn by a web crawler. As shown in FIG. 2, an “X” indicates documents D1-Dn in which the particular keyword was found by the web crawler. Thus, KW1 is contained in D1, D2, D 4, and Dn. Of course, the table in FIG. 2 only illustrates a figurative representation of an inverted index, as one skilled in the art will appreciate that an actual inverted index may not actually be stored as a table.

When embodiments described herein are applied, the inverted index is used by a search engine to identify documents containing keywords in a submitted search-engine query. Documents containing a subset of the keywords in the query are returned to the submitting user. For example, if the query contained keywords KW1-KW6 and the subset was set to N−1 words (i.e., only 5 of 6 words need to be in a document), only D2 would be returned.

Moreover, inverted indexes store locations of documents containing particular keywords. The inverted indexes may also be configured to store additional information relating to either the keyword or the documents. For keywords, the part of speech of an instance of the keyword may be stored—e.g., if the keyword was being used as a noun, verb, adjective, etc. Additionally, alternative spellings may also be stored for the keyword. Examples of the additional information that may be stored for the documents include, without limitation, document identifiers, document URLs, metadata, meta tags, or the like. One skilled in the art will appreciate that various data may be stored to designate particular keywords and documents; therefore, such data need not be discussed at length herein.

The inverted indexes described herein may be a record-level inverted index that contains a list of references to documents for each listed keyword or a word-level inverted index that contains the positions of each keyword within a document. Embodiments may also employ a hybrid of both types.

Keywords, as used herein, are not limited to natural language words. Additionally, keywords may include abbreviations, acronyms, numbers, names, and phrases. For example, a keyword may be “inc.,” “SMTP,” “40,” “John,” or “sign of peace.” While mention is made herein to actual words, any of the above can be used instead.

The term “documents” refers to actual documents, web pages, multimedia (e.g., audio, video, images), or the like that are searchable using a search engine. Documents may be located on networks (e.g., the Internet), within databases, or stored locally on a computing device (e.g., on a local drive, virtual hard drive, or other storage media).

“Relaxed searching” refers to searching for documents that match a subset of the total number of keywords submitted in a search-engine query. Using the terminology above, a subset, in relation to relaxed searching, comprises N−K keywords, with 1≦K<N. This type of searching is referred to as “relaxed,” because it does not require a document to contain all keywords in the search-engine query to be returned within a results list. The identified documents (i.e., those containing N−K keywords) can eventually be listed and presented to the user in a search-results list.

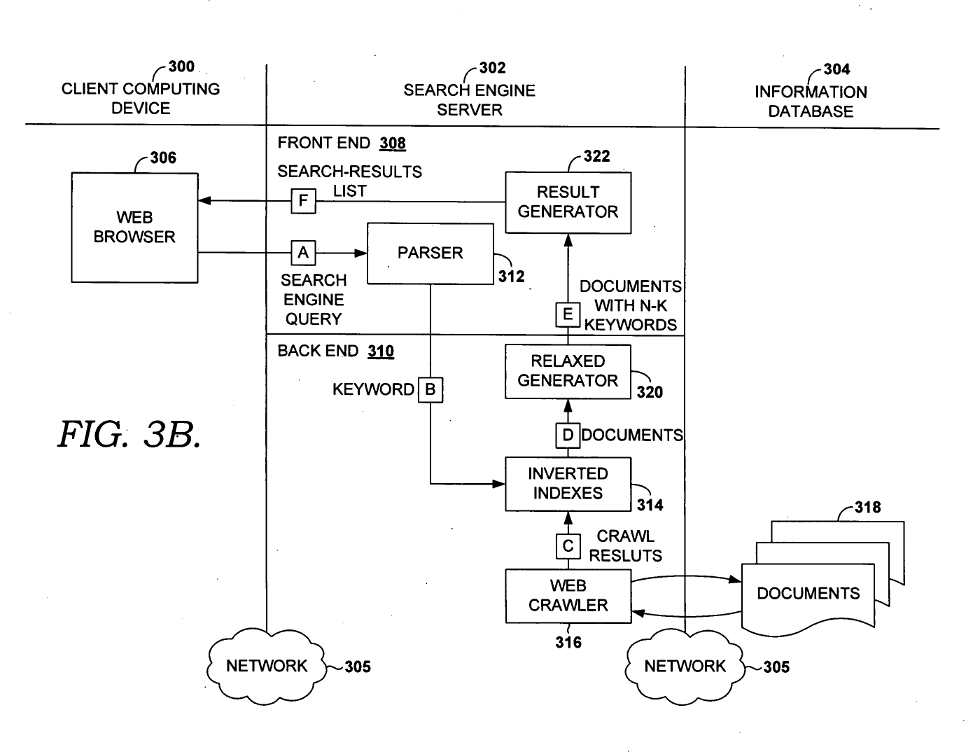

FIG. 3A is a block diagram of a networked environment for performing relaxed searching on a search engine in accordance with an embodiment of the present invention. A client computing device 300, search engine server 302, various information databases 304 are all connected to a network 305. The search-engine server 300 and the information databases 304 may comprise any type of application server, database server, or file server configurable to execute the software described below and manage web documents. In addition, the search-engine server 300 and the information databases 304 may be a dedicated or shared server.

Components of the search-engine server 300 and the information databases 304 may include, without limitation, a processing unit, internal system memory, and a suitable system bus for coupling various system components, including one or more databases for storing information (e.g., files and metadata associated therewith). Each server typically includes, or has access to, a variety of computer-readable media.

While the search-engine server 302 is illustrated as a single box, one skilled in the art will appreciate that the search-engine server 302 is scalable. For example, the search-engine server 302 may actually include multiple servers operating various portions of the software described below. The single unit depictions are meant for clarity, not to limit the scope of embodiments in any form.

In operation, the search-engine server 302 hosts a search engine designed to receive queries from remote computing devices (such as the client computing device 300) and locate information on the Web or within a private network to satisfy the queries. A query is request for documents on the Web that contains specific keywords or phrases. In some embodiments, the search engine executing on the search-engine server 302 uses continually updated inverted indexes—created by web crawlers—to quickly locate web pages satisfying a query. Once the web pages are located, their URLs are transmitted back to the client computing device 202 and displayed as hyperlinks. To access a located web page, a user need only select the corresponding hyperlink. One skilled in the art will appreciate that various other techniques exist for mining information on the Web.

Documents are stored on information databases 304 and accessible via the network 305 using a transfer protocol and relevant URL. The client computing device 300 may fetch a web page by requesting the URL using the transfer protocol. As a result, the web page can be downloaded to the client computing device 300 and stored in memory. The stored web page can then be read by a web browser and presented to a user.

The client computing device 300 may be any type of computing device, such as device 100 described above with reference to FIG. 1. By way of example only but not limitation, the client computing device 300 may be a personal computer, desktop computer, laptop computer, handheld device, cellular phone, digital phone, smartphone, PDA, or the like.

The client computing device 300 may be equipped with a web browser. The web browser is a software application enabling a user to display and interact with information located on the Web. In an embodiment, the web browser communicates with the search-engine server 300 and the information databases 304 using a transfer protocol to fetch documents. Documents may be located by the web browser by sending the transfer protocol and the URL. The web browser can also render pages a number of markup languages (e.g., hypertext markup language (HTML) and extensible markup language (XML)) and execute various scripting languages (e.g., SilverLight™, JavaScript, Flash, Visual Basic Scripting Edition (VBScript), or the like).

The user may navigate to the search engine's web site using the web browser. Once at the web site, the user can submit keywords to the search engine, and the client computing device 300, in turn, transmits the keywords to the search engine server 302. Of course, submitting a query to a search engine is more complicated; however, the communication of queries to waiting instances of a search engine will be readily apparent to those skilled in the art, and thus need not be discussed herein.

In one embodiment, the search engine server 302 receives the query and parses the query into one or more keywords. The search engine server 302 searches one or more inverted indexes for documents that contain N−K keywords. The located documents (i.e., those containing N−K words) are listed in a search-results list and transmitted by the search engine server 302 to the client computing device 300 for display to the user.

In one embodiment, the inverted index is prepared by web crawlers browsing documents stored in the information databases 304. The information databases 304 represent servers that are storing various online documents. For example, the information databases 304 may be hosting a web page comprising numerous online documents.

Network 305 may include any computer network or combination thereof. Examples of computer networks configurable to operate as network 305 include, without limitation, a wireless network, landline, cable line, fiber-optic line, local area network (LAN), wide area network (WAN), metropolitan area network (MAN), or the like. Network 305 is not limited, however, to connections coupling separate computer units. Rather, network 305 may also comprise subsystems that transfer data between servers or computing devices. For example, network 305 may also include a point-to-point connection, the Internet, an Ethernet, a backplane bus, an electrical bus, a neural network, or other internal system.

In an embodiment where network 305 comprises a LAN networking environment, components are connected to the LAN through a network interface or adapter. In an embodiment where network 305 comprises a WAN networking environment, components use a modem, or other means for establishing communications over the WAN, to communicate. In embodiments where network 305 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

Moreover, communication across network 305 may require the illustrated devices to use a communications protocol. Examples of such protocols include, with limitation, the hypertext transfer protocol (HTTP), transmission control protocol (TCP/IP), or the like. One skilled in the art will understand the various protocols that may be used to communicate across network 305; therefore, such protocols need not be discussed at length herein.

In another embodiment, certain keywords in the search-engine query may be designated not to be relaxed, meaning all retrieved documents must include the non-relaxed word. Taking the above example again, “Seattle” in the query “dentists in Seattle Wash.” may be specified not to be relaxed. Consequently, the inverted indexes are analyzed for documents that contain “Seattle” as one of the N−K terms. The following code, or a variant thereof, could be used to designate a non-relaxed keyword class.

```
class NoRelaxTuple : public Tuple
{
public:
    Tuple *m_pConstraint;
    StringBuilder *ToString(StringBuilder *buffer);
    NoRelaxTuple( );
    ~NoRelaxTuple( );
};
```

And the following code or a variant thereof could be used to specify a non-relaxed word in a query.

```
class NoRelaxOperator : public IQueryOperator
{
public:
    void Initialize(QueryParserState *pParser);
    void StartQuery( ) { }
    bool HandleOperator (
        QueryTokenType token,
        const UInt9 *szParsePosition,
        size_t *pcbConsumed);
    void EndQuery( ) { }
};
```

FIG. 3B illustrates a block diagram and the flow of information across a networked environment configured to perform relaxed searching, according to one embodiment. As illustrated, the client computing device 300, search engine 302, and information databases 304, described in reference to FIG. 3A, communicate across network 305. Also, search engine server 302 is illustrated as a singular server with multiple abstracted layers: front end 308 and back end 310. The front end 308 represents the software components that interact with the client computing device 300. And the back end 310 represents the software components that process information for the front end 308 and execute ancillary processes (e.g., web crawling) on background threads. While illustrated on the same server, the front end 308 and back end 310 may, alternatively, be executing on separate servers that are in communication. In fact, the front end 308 and the back end 310 are merely abstractions of different portions of an embodiment of a search engine.

In operation, a user accesses a web site for the search engine using a web browser 306 on the client computing device 300. The user may enter and submit a search-engine query A on the web site, which in turn transmitting the search-engine query A to search engine server 302. In one embodiment, the front end 308 comprises a parser 312, which is software that splits the search-engine query A into individual keywords B. Or the parser 312 may split the search-engine query 312 into phrases of multiple keywords.

The keywords B are passed to one or more inverted indexes 314 on the back end 310. In one embodiment, the back end 310 traverses the entries in the inverted indexes 314 to attempt to locate the keywords. The inverted indexes 314 indicate documents 318 that contain the entries listed in the inverted indexes 314. As previously mentioned, each entry comprises a keyword (not to be confused necessarily with the keywords B) and all of the documents 318 in which the keyword has been located by a web crawler 316. Various information (e.g., document identifiers, URLs, internet protocol (IP) addresses, etc.) for each identified document 318 may be stored in the inverted indexes 314 in association with the keyword.

In one embodiment, the back end 310 searches the inverted indexes 314 for the keywords. In this embodiment, the back end 310 transfers a list of documents D that contain at least one of the keywords B. For example, documents D for keywords “dentists in Seattle Wash.” may include all the documents 318 containing “dentists,” “in,” “Seattle,” and “Washington.” In one embodiment, a relaxed aggregator 320, which is a portion of software executing on the back end 310, searches the documents D for documents that contain N−K keywords B (referred to as documents E).

Documents E (i.e., documents with N−K keywords B) are passed to a results generator 322 on the front end 308. The results generator 322 creates a search-results list F that includes documents E, i.e., those containing N−K of keywords B. For example, URLs for the most frequently accessed documents may be given priority on the list. Alternatively, geographically relevant results, based on the geographic location of the client computing device 300—as determined, for example, by a reverse IP address or global positioning system (GPS) device. One skilled in the art will understand that other alternatives are also possible and need not be discussed at length herein. Eventually, the search-results list F is transmitted to the client computing device 300 and displayed to the user in the web browser 306.

The back end 310 is also configured to operate a web crawler 316 for traversing documents 318 and update the inverted index 314. New entries may be added, existing entries updated, or stale entries deleted. This web crawler 316 may operate on a parallel thread to the relaxed aggregator 320. One skilled in the art will understand web crawlers in detail; therefore, they need not be discussed at length herein.

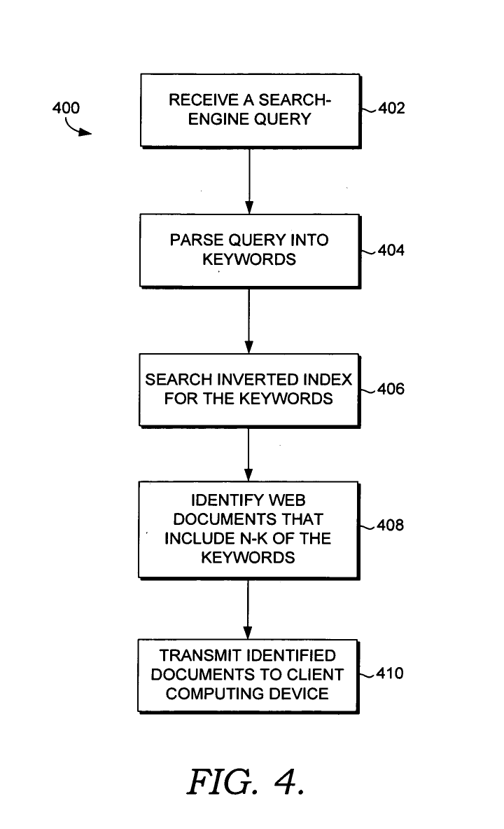

FIG. 4 is a flow diagram illustrating steps (albeit not necessarily sequential) for performing relaxed searching on a search engine, according to one embodiment. Initially, a user submits a search-engine query from a client computing device to a server hosting the search engine, as indicated at 402. The search engine parses the query into keywords, as indicated at 404. Once parsed, each keyword searched for in an inverted index, which contains numerous entries of keywords and the corresponding web documents the keywords can be found in—as indicated at 406. As shown at 408, web documents that have been known to contain at least a portion of the query's keywords—i.e., at least N−K keywords—are identified. And the identified web documents are then transmitted back to the client computing device (indicated at 410) for presentation to the user.

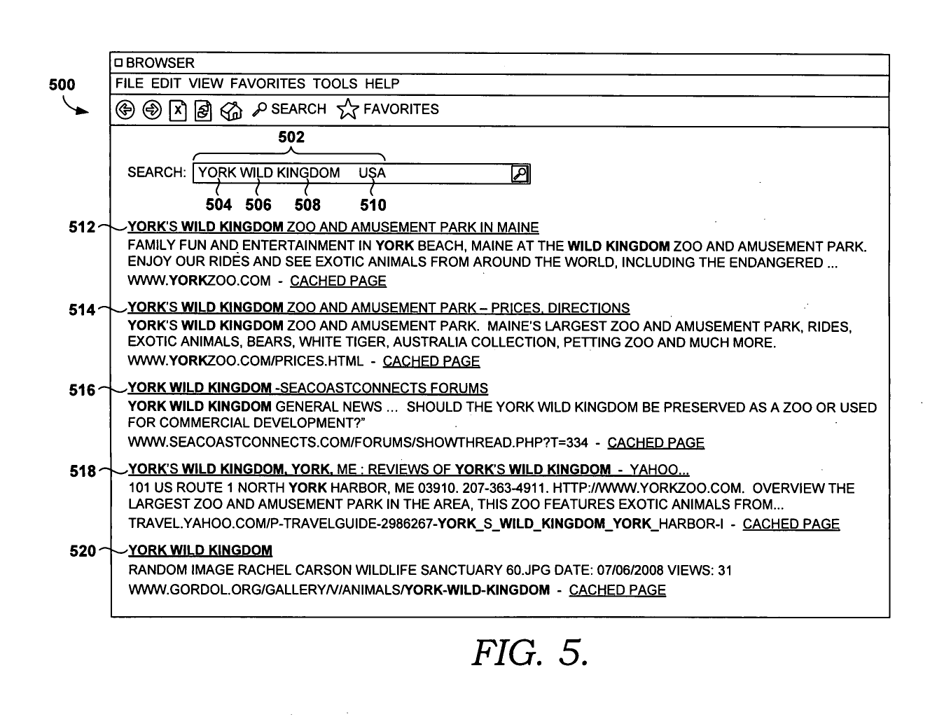

FIG. 5 is a diagram of a search-results list from a search engine performing relaxed searching, according to one embodiment. Specifically, FIG. 6 illustrates a screen shot of a web browser window 500 rendering a web site for the search engine. A user submitted a search-engine query 502 with keywords “york,” “wild,” “kingdom,” and “USA,” referenced as words 504, 506, 508, and 510, respectively. Search-engine query 502 was submitted to the search engine, which returned a list of results that contained N−K keywords. In this instance, N equaled 4 (word 504, word 506, word 508, and word 510) and K was set to 1 by an administrator of the search engine. The resulting documents thus have at least 3 of the 4 keywords 504, 506, 508, and 510. As is shown, results 512, 514, 516, 518, and 520 all contain at least 3 of keywords 504, 506, 508, and 510.

Although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims. For example, sampling rates and sampling periods other than those described herein may also be captured by the breadth of the claims.

The invention claimed is:

1. One or more computer-readable media having computer-executable instructions embodied thereon for performing a method of retrieving and transmitting search results for a query submitted by a user through a search engine, the method comprising:
receiving the query;
parsing the query into one or more keywords;
searching an inverted index for the one or more keywords;
identifying web documents that include fewer than all of the one or more keywords; and
transmitting a list of the web documents.

2. The media of claim 1, wherein the inverted index comprises a plurality of keywords linked to a plurality of web documents containing the plurality of keywords.

3. The media of claim 1, wherein the web documents include all of the one or more keywords minus one keyword.

4. The media of claim 1, wherein the web documents include all of the one or more keywords minus a specific quantity of the one or more keywords.

5. The media of claim 4, wherein the specific quantity of the one or more keywords equals two.

6. The media of claim 1, wherein the web documents include only online documents that contain a non-relaxed keyword of the one or more keywords, wherein the non-relaxed keyword must be contained the web documents.

7. The media of claim 1, wherein the inverted index comprises one more entries that each include a keyword and indications of documents containing the keyword.

8. The media of claim 7, wherein each of the indications comprise at least one of a document identifier, uniform resource locator (URL), and internet protocol (IP) address for one of the documents.

9. The media of claim 7, wherein passing the data packet through the routing component without sampling comprises transmitting the data packet across from the output interface of the routing component and to a network.

10. A method for retrieving and transmitting search results for a query submitted by a user through a search engine, the method comprising:
receiving the query;
parsing the query into one or more keywords;
searching an inverted index for the one or more keywords;
for each of the one or more keywords, identifying a set of one or more web documents that include the each of the one or more keywords;
determining a set of a plurality of web documents containing a subset of the one or more keywords, wherein the subset equals the total number of the one or more keywords (N) minus a specific quantity of keywords (K); and
transmitting a list of the filtered set of web documents.

11. The media of claim 10, wherein searching the inverted index for the one or more keywords further comprises searching the inverted index only for the documents containing N−K keywords.

12. The media of claim 10, further comprising designating at least one of the one or more keywords as a non-relaxed keyword, wherein the non-relaxed keyword must be contained the web documents.

13. The media of claim 10, wherein the inverted index comprises a plurality of keywords linked to a plurality of web documents containing the plurality of keywords.

14. The media of claim 10, wherein the web documents include all of the one or more keywords minus one keyword.

15. The media of claim 10, wherein the web documents include all of the one or more keywords minus a specific quantity of the one or more keywords.

16. The media of claim 15, wherein the specific quantity of the one or more keywords equals two.

17. A computer apparatus for retrieving and transmitting results of a query submitted to a search engine, comprising:
a processor for executing computer-readable instructions;
one or more computer-readable medium configured with the computer-readable instructions;
an inverted index, stored in the computer-readable media and being executed by the processor, configured to receive all keywords in the query and identify web documents containing each of the keywords; and
a relaxed filter set aggregator, stored in the computer-readable media and being executed by the processor, for determining a list of the web documents in the inverted index that contain a subset of the one or more keywords, wherein the subset equals the total number of keywords (N) minus one keyword.

18. The method of claim 17, wherein at least one of the keywords is designated to be contained in each of the web documents.

19. The method of claim 17, wherein the inverted index maintains one or more entries that each include a keyword and at least one document that contains the keyword.

20. The method of claim 19, wherein the inverted index communicates with a web crawler to constantly update the one or more entries.
